(19) United States
(12) Patent Application Publication
(10) Pub. No.: US 2009/0065074 A1
(43) Pub. Date: Mar. 12, 2009

(54) Distribution valve for concrete transport pump

(76) Inventors: Xiaogang Xi, Hunan Province (CN); Yongwei Li, Hunan Province (CN); Jianjun Jiang, Hunan Province (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/919,764

(22) PCT Filed: Jul. 17, 2006
(86) PCT No.: PCT/CN2006/001706

§ 371 Date: Mar. 31, 2008

(30) Foreign Application Priority Data
Jan. 23, 2006 (CN) 200610031179.2

(51) Int. Cl. F16K 5/00

(52) U.S. Cl. 137/565.01

(57) ABSTRACT

Disclosed herein is a distribution valve for concrete transport pump including: a valve body, rocker arm, end covers, a left rotary valve and a right rotary valve. The end covers are disposed on two ends of the valve body. The internal space of the valve body is divided into a left valve chamber and a right valve chamber, with the left rotary valve and the right rotary valve being accommodated respectively in the left valve chamber and the right valve chamber. Inlet ports, intake ports and discharge ports are correspondingly provided in the left valve chamber and the right valve chamber of the valve body respectively. The left rotary valve and the right rotary valve are respectively connected with the rocker arm provided outside of two ends of the valve body through a rotary shaft. Both the left rotary valve and the right rotary valve have a cylindrical shape. Through holes, which communicate the inlet ports to the intake ports or communicate the intake ports to the discharge ports, are provided respectively on the cylindrical surfaces of the left rotary valve and the right rotary valve. The distribution valve for concrete transport pump has a superior intake performance and may achieve a high pressure pumping.

### CROSS-REFERENCES TO RELATED APPLICATIONS

This application claims the benefit of Chinese Patent Application No. 200610031179.2 filed on Jan. 23, 2006.

### FIELD OF THE INVENTION

The present invention generally relates to the field of construction machinery, in particularly to a distribution valve for concrete transport pump.

### BACKGROUND OF THE INVENTION

With the increasing development of the national economy, the construction industry in China is growing rapidly, and large highrise ferroconcrete buildings emerge everywhere. Particularly in recent years, with a rapid development of commercial concrete and its increasingly strict standardization, concrete transport pumps indisputably show their superiority with high efficiency, high quality and low consumption, and those conventional depositing methods are gradually abandoned. Thus, more and more interest is directed toward concrete transport pumps from the domestic and foreign construction industry.

Currently, there basically exist two types of distribution valves for concrete transport pump in the domestic and foreign market: gate valves and S-tube valves. The gate valve is advantageous in its superior intake performance due to a relatively large intake port and absence of structures as an S-tube valve within the hopper, since the only operating member present within the hopper is a stirring vane. Structures within the hopper may not only adversely affect its working capacity but also deteriorate its intake performance. This advantage is more pronounced for concrete with coarse aggregates. However, such a gate valve cannot bear large working pressures (generally about 8 MPa) due to the structural characteristics of its gate leaf, and for a pumping with high pressure cannot be achieved. On the contrary, an S-tube valve is advantageous in that it may bear larger pressure, with a working pressure up to 16 MPa and more, since the high pressure of the system mainly acts on the inner wall of the circular pipe and the wall of the pipe is substantially uniformly tensed. However, the S tube of the S-tube valve is provided in the hopper, which takes up a certain volume of the hopper and adversely affects the intake performance of the pumping cylinder.

### SUMMARY OF THE INVENTION

In view of the technical problem existing in the prior art, it is an object of the invention to provide a distribution valve for concrete transport pump, which has a superior intake performance and may achieve a high pressure pumping.

To achieve the above object, the present invention provides a distribution valve for concrete transport pump, including: a valve body, rocker arms, end covers, a left rotary valve and a right rotary valve, with the end covers disposed on two ends of the valve body, wherein the internal space of the valve body is divided into a left valve chamber and a right valve chamber, with the left rotary valve and the right rotary valve being accommodated respectively in the left valve chamber and the right valve chamber; inlet ports, intake ports and discharge ports are correspondingly provided in the left valve chamber and the right valve chamber of the valve body respectively; the left rotary valve and the right rotary valve are respectively connected with the rocker arm provided outside of the two ends of the valve body through a rotary shaft; and both the left rotary valve and the right rotary valve have a cylindrical shape, with two through holes, which communicate the inlet ports to the intake ports or communicate the intake ports to the discharge ports, provided respectively on the cylindrical surfaces of the left rotary valve and the right rotary valve.

The calibers at the two ends of the through holes are different from each other, with the caliber at the end communicating to the intake port greater than that at the end communicating to the inlet port or the discharge port.

When the left inlet port and the left intake port of the left valve chamber are communicated with each other via the left through hole, the right intake port and the right discharge port of the right valve chamber are communicated with each other via the right through hole; and when the left intake port and the left discharge port of the left valve chamber are communicated with each other via the left through hole, the right inlet port and the right intake port of the right valve chamber are communicated with each other.

The left valve chamber and the right valve chamber in the valve body are formed by the separation of a separate collar or a separate plate.

An outer lining and an inner lining are provided between the left rotary valve and the valve body as well as between the right rotary valve and the valve body.

The rotary shaft is secured to a bearing seat and a bearing on the end cover, with a seal ring provided between the rotary shaft and the end cover.

Compared with the prior art, the present invention has the following advantages. The distribution valve for concrete transport pump according to the present invention provides a configuration in which the distribution valve and the hopper are arranged separately such that the available volume of the hopper may increase to facilitate a better stirring of the vanes thereof. The inlet ports are slanted downwardly, which facilitates a better feeding of materials. Such a configuration is especially advantageous for pumping coarse materials. Meanwhile, during the pumping process, since the through hole of the distribution valve has a substantially cylindrical shape, the pumping pressure may be distributed uniformly on the wall of the through hole and the wall may be uniform tensed, which leads to an improved strength of the valve. During the intake step, the rotary valve closes the discharge port and receives back pressure from the delivery pipe. At this time, the rotary valve portion which closes the discharge port is provided with a cylindrical surface, which can uniformly transfer the back pressure to the cylinder and further to the valve body via the rotary valve. Thus the rotary valve is prevented from being locally stressed and a development of ruptures or breakages at the weakest points of the rotary valve.

### BRIEF DESCRIPTION OF THE DRAWINGS

FIG. 1 is a front view illustratively showing the structure of the invention;

FIG. 2 illustrates a sectional view through line A-A in FIG. 1;

FIG. 3 illustrates the structure of a chamber in which the left rotary valve is provided, wherein the distribution valve of the invention is operating;

FIG. 4 illustrates the structure of a chamber in which the right rotary valve is provided, wherein the distribution valve of the invention is operating;

FIG. 5 illustrates the structure of the left rotary valve of the invention; and

FIG. 6 illustrates an installation diagram of the invention.

### LIST OF THE REFERENCE NUMERALS

1 rocker arm 2 end cover 3 outer lining 4 left rotary valve 5 valve body 6 key 7 inner lining 8 separate collar 9 right rotary valve 10 seal ring 11 bearing seat 12 bearing 13 fastening nut 14 rotary shaft 15 left through hole 16 left inlet port 17 left intake port 18 left discharge port 19 right through hole 20 right inlet port 21 right intake port 22 right discharge port 51 left valve chamber 52 right valve chamber

### DETAILED DESCRIPTION OF THE INVENTION

The present invention will be described in more detail with reference to the exemplary embodiments and the accompanying figures.

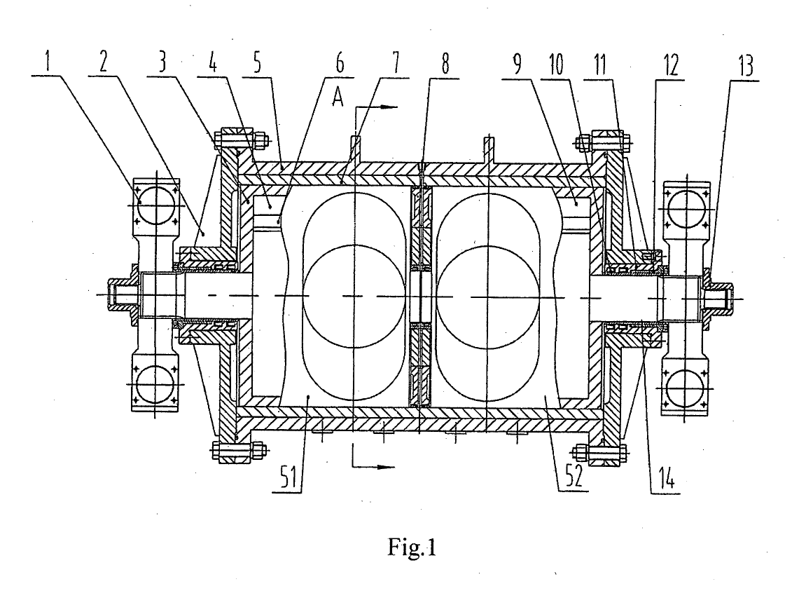

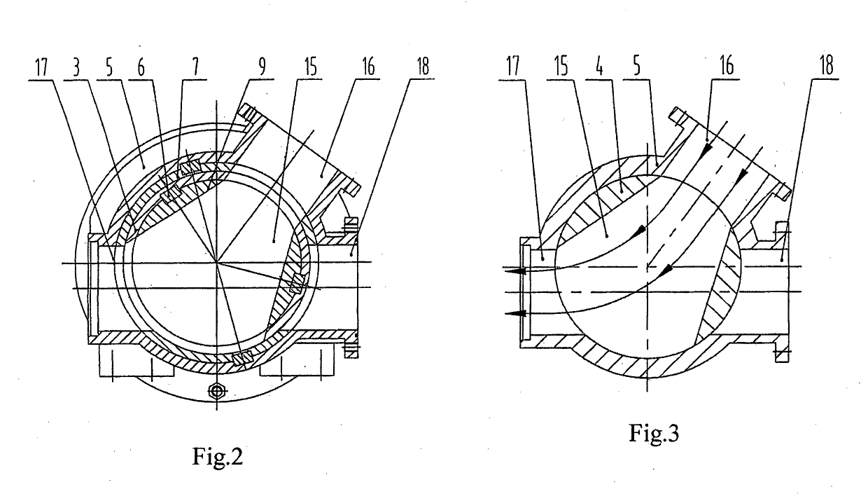

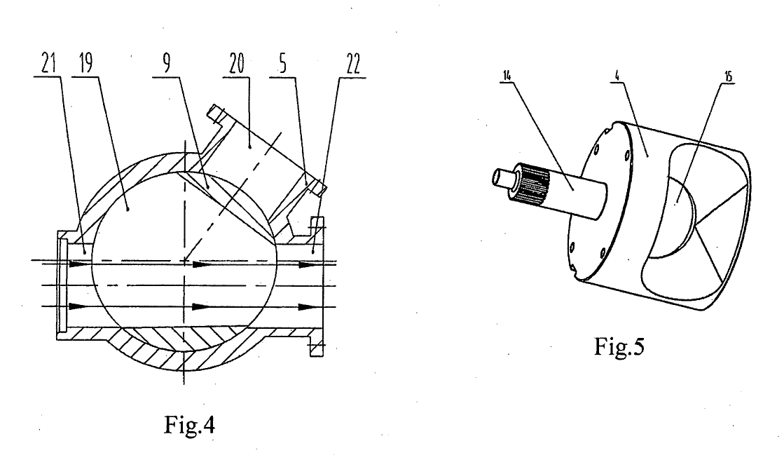

As shown in FIGS. 1, 2 and 6, the distribution valve for concrete transport pump according to the present invention comprises a valve body 5, rocker arms 1, end covers 2, a left rotary valve 4 and a right rotary valve 9. The end covers 2 are disposed on the two ends of the valve body 5 respectively. The cylindrical internal space of the valve body 5 is divided into a left valve chamber 51 and a right valve chamber 52 by a separate collar 8 or a separate plate. An oil channel is provided on the separate collar 8 through which lubricating oil under high pressure is supplied to lubricate the valve body 5 and to prevent penetration of concrete grout. A seal member is provided on the separate collar 8 to prevent the communication of the two chambers. The left rotary valve 4 and the right rotary valve 9 that may rotate freely are arranged in the left valve chamber 51 and the right valve chamber 52 respectively, with an outer lining 3 and an inner lining 7 being provided between the left rotary valve 4 and the valve body 5 as well as the right rotary valve 9 and the valve body 5 via a key 6. Thus, the left rotary valve 4 and the right rotary valve 9 are prevented from being worn out and shortening the life thereof since it is the outer lining 3 and inner lining 7 that are worn out. Inlet ports, intake ports and discharge ports are provided in the left valve chamber 51 and the right valve chamber 52 of the valve body 5 respectively. The left rotary valve 4 and the right rotary valve 9 are respectively connected to the rocker arms provided outside of the two ends of the valve body 5 by a rotary shaft 14 and splines, wherein the rocker arms 1 are connected with the axle heads of the left rotary valve 4 and the right rotary valve 9 through splines and then secured by fastening nuts 13. A reciprocative movement of a piston in an oil cylinder causes the rocker arms 1 to rotate, therefore driving the left rotary valve 4 and the right rotary valve 9 via the splines so as to switch the valves. The rotary shaft 14 is secured to a bearing seat 11 and a bearing 12 on the end cover 2, with a seal ring 10 provided between the rotary shaft 14 and the end cover 2. As shown in FIG. 5, both the left rotary valve 4 and the right rotary valve 9 have a cylindrical shape. Through holes are provided on the cylindrical surfaces of the left rotary valve and the right rotary valve to communicate the inlet port to the intake port or to communicate the intake port to the discharge port. The calibers at the two ends of the through hole are different from each other, wherein the caliber at the end communicating to the intake port is greater than that at the end communicating to the inlet port or the discharge port. As shown in FIGS. 3 and 4, in a certain operating state, when the left inlet port 16 and the left intake port 17 of the left valve chamber 51 are communicated with each other via the left through hole 15, the right intake port 21 and the right discharge port 22 of the right valve chamber 52 are communicated with each other via the right through hole 19. Similarly, in another operating state, when the left intake port 17 and the left discharge port 18 of the left valve chamber 51 are communicated with each other via the left through hole 15, the right inlet port 20 and the right intake port 21 of the right valve chamber 52 are communicated with each other.

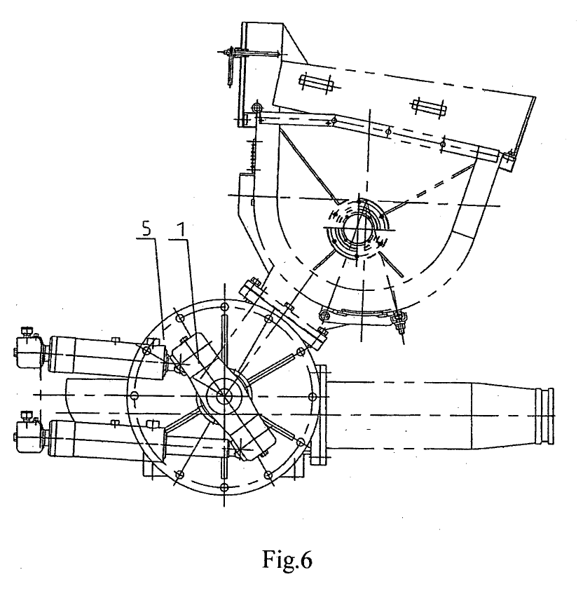

The operating principle of the invention is described as follows. The distribution valve for concrete transport pump according to the present invention is mounted in the pumping system of the concrete transport pump. The pumping system comprises a hopper, a Y-shaped pipe, the distribution valve, a pumping cylinder, a main oil cylinder, a rocker mechanism etc. As shown in FIG. 6, the oil cylinder of the left rocker mechanism moves the rocker arm 1 thus drives the left rotary valve 4 to rotate so that the left through hole 15 in the left rotary valve 4 communicates the left inlet port 16 to the left intake port 17. Afterwards, the left main oil cylinder moves backward and the concrete in the hopper is drawn to the left pumping cylinder via the left through hole 15 of the distribution valve, thus the intake process is completed. After the left main oil cylinder moves backward to its position, the oil cylinder of the rocker mechanism operates to move the rocker arm 1 and drives the left rotary valve 4 to rotate in an opposite direction, so that the left through hole 15 in the left rotary valve 4 communicates the left intake port 17 to the left discharge port 18 with a simultaneous shut off of the left inlet port 16. After that, the left main oil cylinder moves forwardly and pumps the concrete in the hopper into the Y-shaped pipe and the delivery pipe via the left through hole 15 of the distribution valve. Similarly, the oil cylinder of the right rocker mechanism moves the rocker arm 1 thus drives the right rotary valve 9 to rotate so that the right through hole 19 in the right rotary valve 9 communicates the right inlet port 20 to the right intake port 21. Afterwards, the right main oil cylinder moves backward and the concrete in the hopper is drawn to the right pumping cylinder via the right through hole 19 of the distribution valve, thus the intake process is completed. After the right main oil cylinder moves backward to its position, the oil cylinder of the rocker mechanism operates to move the rocker arm 1 and drives the right rotary valve 9 to rotate in an opposite direction, so that the right through hole 19 in the right rotary valve 9 communicates the right intake port 21 to the right discharge port 22 with a simultaneous shut off of the right inlet port 20. After that, the right main oil cylinder moves forwardly and pumps the concrete in the hopper into the Y-shaped pipe and the delivery pipe via the right through hole 19 of the distribution valve. When the left half of the distribution valve is under the intake mode, the right half thereof will be under the pumping mode; afterward, the left half will be brought into the pumping mode, and the right half will be put into the intake mode. Therefore, pumping operation and intake operation are conducted alternatively at the left side and the right side, thus completing the whole process.

1. A distribution valve for concrete transport pump, comprising:
a valve body (5), rocker arms (1), end covers (2), a left rotary valve (4) and a right rotary valve (9), with the end covers (2) disposed on two ends of the valve body (5), wherein
the internal space of the valve body (5) is divided into a left valve chamber (51) and a right valve chamber (52), with the left rotary valve (4) and the right rotary valve (9) being accommodated respectively in the left valve chamber (51) and the right valve chamber (52);
inlet ports, intake ports and discharge ports are correspondingly provided in the left valve chamber (51) and the right valve chamber (52) of the valve body (5) respectively;
the left rotary valve (4) and the right rotary valve (9) are respectively connected with the rocker arm (1) provided outside of the two ends of the valve body (5) through a rotary shaft (14); and
both the left rotary valve (4) and the right rotary valve (9) have a cylindrical shape, with through holes, which communicate the inlet ports to the intake ports or communicate the intake ports to the discharge ports, provided respectively on the cylindrical surface of the left rotary valve and the right rotary valve.

2. The distribution valve for concrete transport pump according to claim 1, wherein the calibers at the two ends of the through holes are different from each other, the caliber at the end communicating to the intake port is greater than that at the end communicating to the inlet port or the discharge port.

3. The distribution valve for concrete transport pump according to claim 1, wherein
when the left inlet port (16) and the left intake port (17) of the left valve chamber (51) are communicated with each other via the left through hole (15), the right intake port (21) and the right discharge port (22) of the right valve chamber (52) are communicated with each other via the right through hole (19); and
when the left intake port (17) and the left discharge port (18) of the left valve chamber (51) are communicated with each other via the left through hole (15), the right inlet port (20) and the right intake port (21) of the right valve chamber (52) are communicated with each other.

4. The distribution valve for concrete transport pump according to claim 1, wherein the left valve chamber (51) and the right valve chamber (52) in the valve body (5) are formed by the separation of a separate collar (8) or a separate plate.

5. The distribution valve for concrete transport pump according to claim 3, wherein the left valve chamber (51) and the right valve chamber (52) in the valve body (5) are formed by the separation of a separate collar (8) or a separate plate.

6. The distribution valve for concrete transport pump according to claim 1, wherein an outer lining (3) and an inner lining (7) are provided between the left rotary valve (4) and the valve body (5) and between the right rotary valve (9) and the valve body (5).

7. A distribution valve for concrete transport pump according to claim 3, wherein an outer lining (3) and an inner lining (7) are provided between the left rotary valve (4) and the valve body (5) and between the right rotary valve (9) and the valve body (5).

8. The distribution valve for concrete transport pump according to claim 5, wherein an outer lining (3) and an inner lining (7) are provided between the left rotary valve (4) and the valve body (5) and between the right rotary valve (9) and the valve body (5).

9. The distribution valve for concrete transport pump according to claim 1, wherein the rotary shaft (14) is secured to a bearing seat (11) and a bearing (12) on the end cover (2), and a seal ring (10) is provided between the rotary shaft (14) and the end cover (2).

10. The distribution valve for concrete transport pump according to claim 8, wherein the rotary shaft (14) is secured to a bearing seat (11) and a bearing (12) on the end cover (2), and a seal ring (10) is provided between the rotary shaft (14) and the end cover (2).

11. A distribution valve for concrete transport pump, comprising:
a valve body (5), rocker arms (1), end covers (2), a left rotary valve (4) and a right rotary valve (9), with the end covers (2) disposed on two ends of the valve body (5), wherein
the internal space of the valve body (5) is divided into a left valve chamber (51) and a right valve chamber (52), with the left rotary valve (4) and the right rotary valve (9) being accommodated respectively in the left valve chamber (51) and the right valve chamber (52);
inlet ports, intake ports and discharge ports are correspondingly provided in the left valve chamber (51) and the right valve chamber (52) of the valve body (5) respectively;
the left rotary valve (4) and the right rotary valve (9) are respectively connected with the rocker arm (1) provided outside of the two ends of the valve body (5) through a rotary shaft (14); and
both the left rotary valve (4) and the right rotary valve (9) have a cylindrical shape, with through holes, which communicate the inlet ports to the intake ports or communicate the intake ports to the discharge ports, provided respectively on the cylindrical surface of the left rotary valve and the right rotary valve, wherein the calibers at the two ends of the through holes are different from each other, the caliber at the end communicating to the intake port is greater than that at the end communicating to the inlet port or the discharge port.

12. The distribution valve for concrete transport pump according to claim 11, wherein
when the left inlet port (16) and the left intake port (17) of the left valve chamber (51) are communicated with each other via the left through hole (15), the right intake port (21) and the right discharge port (22) of the right valve chamber (52) are communicated with each other via the right through hole (19); and
when the left intake port (17) and the left discharge port (18) of the left valve chamber (51) are communicated with each other via the left through hole (15), the right inlet port (20) and the right intake port (21) of the right valve chamber (52) are communicated with each other.

13. The distribution valve for concrete transport pump according to claim 11, wherein the left valve chamber (51) and the right valve chamber (52) in the valve body (5) are formed by the separation of a separate collar (8) or a separate plate.

14. The distribution valve for concrete transport pump according to claim 12, wherein the left valve chamber (51) and the right valve chamber (52) in the valve body (5) are formed by the separation of a separate collar (8) or a separate plate.

15. The distribution valve for concrete transport pump according to claim 11, wherein an outer lining (3) and an inner lining (7) are provided between the left rotary valve (4) and the valve body (5) and between the right rotary valve (9) and the valve body (5).

16. A distribution valve for concrete transport pump according to claim 12, wherein an outer lining (3) and an inner lining (7) are provided between the left rotary valve (4) and the valve body (5) and between the right rotary valve (9) and the valve body (5).

17. The distribution valve for concrete transport pump according to claim 14, wherein an outer lining (3) and an inner lining (7) are provided between the left rotary valve (4) and the valve body (5) and between the right rotary valve (9) and the valve body (5).

18. The distribution valve for concrete transport pump according to claim 11, wherein the rotary shaft (14) is secured to a bearing seat (11) and a bearing (12) on the end cover (2), and a seal ring (10) is provided between the rotary shaft (14) and the end cover (2).

19. The distribution valve for concrete transport pump according to claim 17, wherein the rotary shaft (14) is secured to a bearing seat (11) and a bearing (12) on the end cover (2), and a seal ring (10) is provided between the rotary shaft (14) and the end cover (2).
